(19) United States
(12) Patent Application Publication
(10) Pub. No.: US 2017/0242981 A1
(43) Pub. Date: Aug. 24, 2017

(54) SIMULATION OF CHEMICAL PROCESS FACILITIES

(71) Applicant: Honeywell International Inc., Morris Plains, NJ (US)

(72) Inventor: BRIAN M. DEVEREUX, ELK GROVE VILLAGE, IL (US)

(21) Appl. No.: 15/143,883

(22) Filed: May 2, 2016

Related U.S. Application Data
(60) Provisional application No. 62/298,786, filed on Feb. 23, 2016.

(51) Int. Cl. G06F 19/00; G06F 17/11

(52) U.S. Cl. CPC G06F 19/701; G06F 17/11

(57) ABSTRACT

A method for simulating a chemical process. A process simulator is provided having a processor configured to execute a process model for simulating the chemical process using a flowsheet having a flowsheet topology. The flowsheet topology defines a flow of the chemical process including unit operations connected by fixed process stream connections. The process simulator represents each of the unit operations on the display with several user selectable unit operation options (operation options) that each have its own stored specification parameters. The user is allowed to select at least a first specific set of the operation options. The process simulator generates the flowsheet topology customized with the first specific set of the operation options. A graphical display presentation is generated on the display showing the flowsheet topology customized with the first specific set of the operation options.

### CROSS REFERENCE TO RELATED APPLICATIONS

This application claims the benefit of Provisional Application Ser. No. 62/298,786 entitled “SIMULATION OF CHEMICAL PROCESS FACILITIES”, filed Feb. 23, 2016, which is herein incorporated by reference in its entirety.

### FIELD

Disclosed embodiments relate to simulation of chemical processes.

### BACKGROUND

Chemical process facilities can include manufacturing plants, chemical plants, crude oil refineries, ore processing plants, and paper or pulp manufacturing plants. These industries typically use continuous processes and fluid processing. Process simulation tools have been used to model the behavior of industrial and chemical processes. The simulation tools can reduce the efforts needed to develop representative process models. Chemical process simulators are a simulation tool that models the behavior of chemical processes such as those in a chemical process facility.

### SUMMARY

This summary is provided to introduce a brief selection of disclosed concepts in a simplified form that are further described below in the Detailed Description including the drawings provided. This Summary is not intended to limit the claimed subject matter's scope.

Disclosed embodiments comprise a method of chemical process simulation. The method includes providing a process simulator including a processor configured to execute a process model for simulating a chemical process using a flowsheet having a flowsheet topology.

As known in the art, a flowsheet topology defines a general flow of the chemical process including unit operations connected by fixed process stream connections. The process simulator has an associated display with a graphic user interface (GUI) for interacting with the user. The process simulator represents each of the unit operations on the display with several user selectable unit operation options (operation options) that each have its own stored specification parameters. Using the GUI, the user is allowed to select at least a first specific set of the operation options including one selection from each of the operation options. Using the first specific set of the operation options, the process simulator generates the flowsheet topology customized with the first specific set of the operation options. A graphical display presentation is generated on the display showing the flowsheet topology customized with the first specific set of the operation options.

Another disclosed embodiment comprises a chemical process simulation system. The system includes a process simulation computer including a processor connected to a memory device having a first non-transitory machine-readable storage medium storing process modeling software that implements a disclosed process simulator. The processor is programmed to implement the process modeling software to execute a process model for simulating a chemical process using a flowsheet having a flowsheet topology. The process simulator has an associated display with GUI for interacting with the user. The process simulator represents each of the unit operations on the display with several user selectable unit operation options (operation options) that each have its own stored specification parameters. Using the graphic user interface, the user is allowed to select at least a first specific set of the operation options including one selection from each of the operation options. Using the first specific set of the operation options, the process simulator generates the flowsheet topology customized with the first specific set of the options. A graphical display presentation is generated on the display showing the flowsheet topology customized with the first specific set of the operation options.

### BRIEF DESCRIPTION OF THE DRAWINGS

FIG. 1 is a block diagram of an example chemical process simulation system that implements a disclosed process simulator for simulating a chemical process facility, according to an example embodiment.

FIG. 2 is a block diagram of an example process computer implementing a disclosed chemical process simulation system that implements a disclosed process simulator, according to an example embodiment.

FIG. 3 is an example display of a simulation performed by a chemical process simulation system based on user' selection of several simulated unit operations, according to an example embodiment.

FIG. 4 is a flow chart that shows steps in an example method of chemical process simulation, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Disclosed embodiments recognize conventional chemical process simulators only represent a single simulation case with a fixed topology and with a fixed set of unit operations. While it is generally a simple matter to evaluate the performance of the unit operations by modifying the available operation parameters, there is no ability to easily specify alternate unit operations which can involve a completely different sets of parameters. The simulation of scenarios involving sets of alternate operations using conventional process simulators generally requires disconnecting the stream connections to the existing operations, reconnecting the streams to the replacement operations, and then running a new simulation. This procedure needs to be repeated every time a new combination of operations required evaluation. Such conventional chemical process simulators render it not possible to quickly perform a case study or optimization for the best possible combination of operations since the simulator does not store information about the range of possible operations.

Disclosed chemical process simulation solves the above-described problems with conventional chemical process simulators by providing a chemical process simulation system referred to as a process simulator which stores discrete sets of alternate unit operations in a simulation case of fixed topology. This allows the process simulator to use various optimization methods (e.g., mixed integer non-linear programming (MINLP)) to find process solutions over the space of discrete combinations of alternative operation choices.

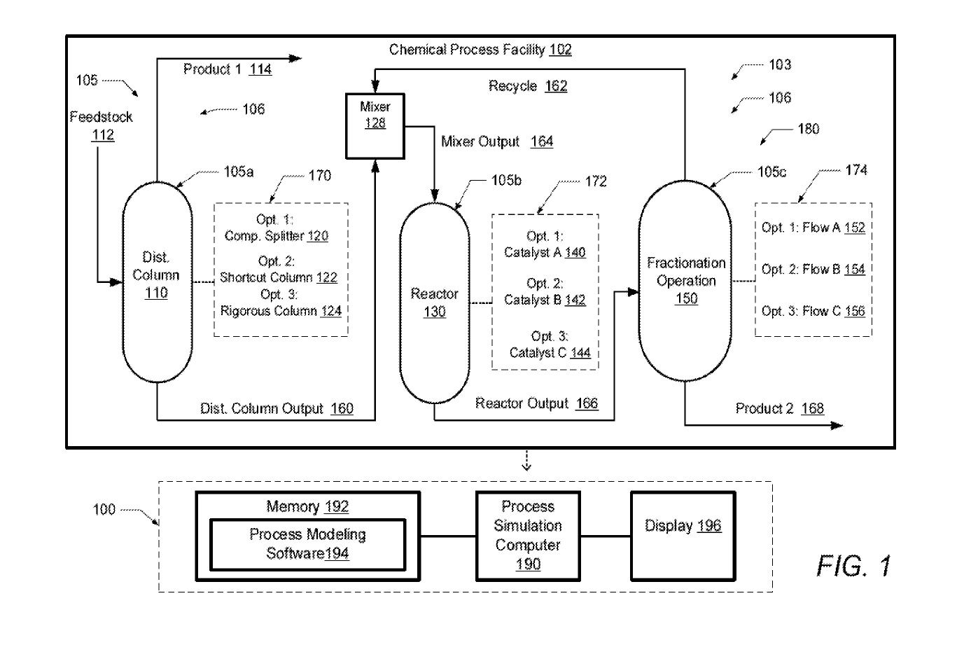

FIG. 1 illustrates a block diagram of an example chemical process simulator system 100 that implements a disclosed process simulator for simulating a chemical process facility 102. Chemical process facility 102 can be any of a variety of manufacturing or processing plants that handle, process, store and transport liquid or fluid chemicals and materials. Chemical process facility 102 can include manufacturing plants, chemical plants, crude oil refineries, ore processing plants, paper manufacturing plants and water processing plants. These industries and facilities typically use continuous processes and fluid processing.

Chemical process facility 102 includes various process elements or unit operations 105 including 105a, 105b and 105c that are inter-connected connected via pipes or conduits represented as various flow streams or fixed process stream connections 106. Chemical process facility 102 is represented by a flowsheet 103 having a flowsheet topology. As known in the art, the flowsheet topology defines a general flow of the chemical process including the unit operations connected by fixed process stream connections 106. In one embodiment, flowsheet 103 can include one or more nested sub-flowsheets. Nested sub-flowsheets are self-contained modules including one or more portions of the overall flowsheet 103.

Unit operations can include a wide variety of chemical process units such as distillation columns, reactors, fractionation operations, heaters, holding tanks, valves, catalytic converters, mixers, separators, reactors, compressors, grinders, floatation tanks, pumps, expanders, distillation units, surge tanks, accumulators, relief valves, absorbers, filters, and heat exchangers. Each unit operation 105 performs a function involving one or more chemical ingredients or other products. For example, a chemical processing plant can include a distillation column that separates constituent chemical ingredients into individual components based on vapor condensing points to produce a desired chemical product. Chemical process facility 102 can produce several different types of chemical products. The production of each product can be performed by one or more of the unit operations.

As shown in FIG. 1, unit operation 105a includes a distillation column 110, where a mixer 128 couples the distillation column 110 to a reactor 130 of unit operation 105b, and to a fractionation operation 150 of unit operations 105c. Flow streams or fixed process stream connections 106 in chemical process facility 102 include feedstock 112, product 1 114, distillation column output 160, recycle 162, mixer output 164, reactor output 166 and product 2 168. Each of the unit operations 105a, 105b, 105c can include several operation options. Distillation column 110 can have operation options 170. Reactor 130 can have can have operation options 172, and fractionation operation 150 can have operation options 174.

Operation options 170 include option 1, a component splitter 120, option 2, a shortcut column 122 and option 3 a rigorous column 124. Each of the operation options 170 represents different distillation column 110 designs with different heights, diameters, tray spacing and temperatures. Operation options 172 include option 1, catalyst A 140, option 2, a catalyst B 142 and option 3, catalyst C 144. Each of the operation options 172 represents a different catalyst compound in reactor 130. Operation options 174 include option 1, flow A 152, option 2, flow B 154 and flow C 156. Each of the operation options 174 represents a different flow of compounds within fractionation operation 150.

The operation of chemical process facility 102 is simulated using process simulator system 100. Process simulator system 100 includes a process simulation computer 190 that is coupled to a storage device such as memory 192 and a display 196. Memory 192 stores process modeling software 194. Process modeling software 194 when executed by the process simulation computer 190 can perform any one or more of the methods, processes, operations, applications, or methodologies described herein. Specifically, process simulation computer 190 executing process modeling software 194 can receive information, parameters and operation options defining several simulated unit operations associated with the chemical process facility, generate several combinations 180 of the simulated unit operations for simulation within the process model, wherein each of the combinations 180 represents a fixed set of the unit operations to be simulated and generate a graphical display presentation of the combinations of the simulated unit operations on a display device.

The process simulation computer 190 executing process modeling software 194 can interact with a user via display 196 with a GUI for interacting with the user. The process simulator represents each of the unit operations 105a, b, c on the display 196 with several user selectable unit operation options (operation options) that each have their own stored specification parameters.

For every unit operation 105a, 105b, 105c in the simulation a user can specify a enumerable set of independent operation options (170 associated with unit operation 105a, 172 associated with unit operation 105b, and 174 associated with unit operation 105c) with the same set of feed (112) and product streams (114, 168). The operation options can have a variety of different uses and different types of unit operations (typically in the same class) with different underlying models/user interfaces/specifications. For example, reactor 130 can be different reactor types such as a plug flow reactor or a continuous stirred tank reactor. Distillation column 110 can have alternate columns specs, number of trays and feed tray location or switching between component splitters/shortcut distillation columns/rigorous distillation columns. Fractionation operation 150 can have different fractionation flow schemes. The operation options (170, 172, 174) enable stored sets of operation choices to be easily modified, simulated, analyzed and optimized across multiple combinations of operation options by process simulation computer 190.

As shown in FIG. 1, with of each of the independent operation options 170, 172, 174 for the unit operations 105a, 105b, 105c having three possible values, a total of 3³=27 different possible combinations 180 of the fixed topology unit operations are possible. Any of the 27 possible combinations 180 can be simulated using the process simulator system 100 in order to optimize the processes within chemical process facility 102.

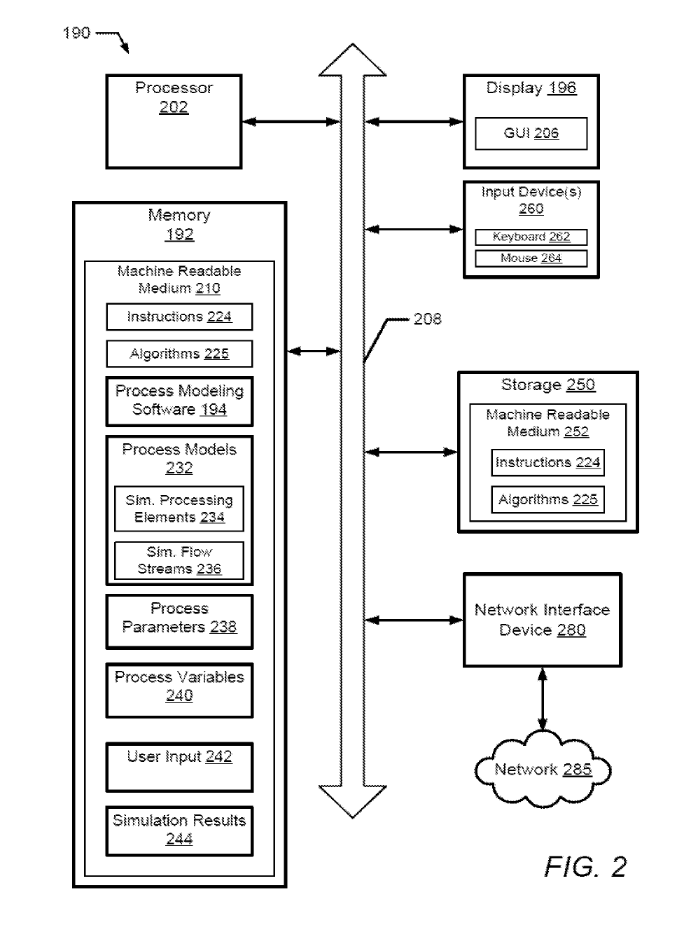

FIG. 2 illustrates an example block diagram of process simulation computer 190 within which a set of instructions 224 and/or algorithms 225 can be executed causing the process simulation computer 190 to perform any one or more of the methods, processes, operations, applications, or methodologies described herein. Process simulation computer 190 includes one or more processors 202 such as a central processing unit (CPU), digital signal processor (DSP), and micro-processor or micro-controller unit (MCU). Processor 202 is communicatively coupled to a storage device such as memory 192, which communicate with each other via system bus 208 which can represent a data bus and an address bus. Memory 192 includes a machine readable medium 210 on which is stored one or more sets of software such as instructions 224 and/or algorithms 225 embodying any one or more of the methodologies or functions described herein. Memory 192 can store instructions 224 and/or algorithms 225 for execution by processor 202.

The process simulation computer 190 can further include display 196 such as a video screen that is connected to system bus 208. In one embodiment, display 196 can be a touch screen that can accept user' input. Processor 202 can show a GUI 206 to a user on display 196. The process simulation computer 190 also has input devices 260 such as an alphanumeric input device (e.g., keyboard 262) and a cursor control device (e.g., a mouse 264) that are connected to system bus 208.

A storage device 250, such as a hard drive or solid state drive, is connected to and in communication with the system bus 208. The storage device 250 includes a machine readable medium 252 on which is stored one or more sets of software such as instructions 224 and/or algorithms 225 embodying any one or more of the methodologies or functions described herein. The instructions 224 and/or algorithms 225 can also reside, completely or at least partially, within the memory 192 and/or within the processor 202 during execution thereof.

While the machine readable medium 210 and 252 are shown in an example embodiment to be a single medium, the term “machine readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding or carrying a set of instructions for execution by the computer system and that cause the computer system to perform any one or more of the methodologies shown in the various embodiments of the present invention. The term “machine readable medium” shall accordingly be taken to include, but not be limited to, solid-state memories, optical and magnetic media, and carrier wave signals.

Process simulation computer 190 further includes a network interface device 280 that is connected to system bus 208. Network interface device 280 is coupled to communication network 285. Communication network 285 can be a wide variety of communication systems such as hardwired networks including the internet or wireless networks including Wi-Fi or local area networks.

Machine readable medium 210 further stores process modeling software 194 and process models 232. Process modeling software 194 when executed by processor 202 simulates the operation of chemical process facility 102 using combinations of the simulated unit operations for simulation within the process model as specified by a user. Process models 232 include simulated processing elements 234 and simulated flow streams or fixed process stream connections 236. Simulated processing elements 234 are simulations/models/algorithms of unit operations 105 and operation options 170-174. Simulated flow streams 236 are simulations/models/algorithms of flow streams 106.

Machine readable medium 210 further also stores process parameters 238, process variables 240, user input 242 and simulation results 244. Process parameters 238 are parameters used by process models 232 during the simulation of chemical process facility 102. Process variables 240 are variables used by process models 232 during the simulation of chemical process facility 102. User input 242 is received via input devices 260 and display 196, if display 196 is a touch screen device. Simulation results 244 are shown to a user on display 196.

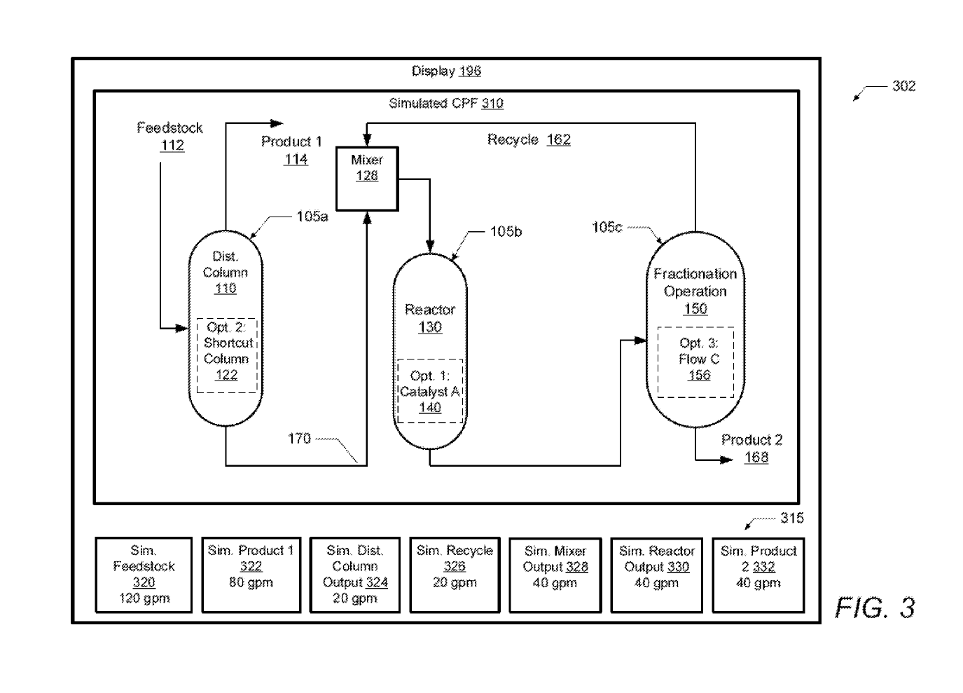

FIG. 3 illustrates an example screenshot 302 on a display 196 of a simulation performed by an example chemical process simulation system based on user' selection of several simulated unit operations at a chemical process facility (CPF) 310. Screenshot 302 is generated by process modeling software 194 executing on processor 202. Screenshot 302 shows the simulation results 244 on display 196. In FIG. 3, a user has selected option 2 shortcut column 122 from the operation options 170, option 1 catalyst A 140 from the operation options 172 and option 3 flow C 156 from the operation options 174 as the user input 242 shown in FIG. 2.

In one embodiment, the processor 202 can cause display 196 to display a graphical display presentation of all of the combinations of the operation options of the simulated unit operations on display 196. Processor 202 executing the process modeling software 194 of the process simulator system 100 generates the flowsheet topology customized with the specific set of the operation options selected by the user. A graphical display presentation (e.g., screenshot 302) is generated on the display 196 showing the flowsheet topology customized with the selected specific set of the operation options. In the embodiment shown in FIG. 3, only the user' selected combination of operation options of the unit operations are shown. In one embodiment, the selected operation options can be shown on display 196 with one type of indicia or color and the non-selected operation options can be shown on display 196 with another type of indicia or color.

Screenshot 302 further includes simulated flow stream results 315 showing example simulated values. Simulated flow stream results 315 are the amounts of products produced as simulated by process models 232. Simulated flow stream results 315 include simulated feedstock 320, simulated product 1 322, simulated distillation column output 324, simulated recycle 326, simulated mixer output 328, simulated reactor output 330 and simulated product 2 332. Simulated flow stream results 315 can be in units of material produced or throughput in a time period such as gallons per minute (GPM).

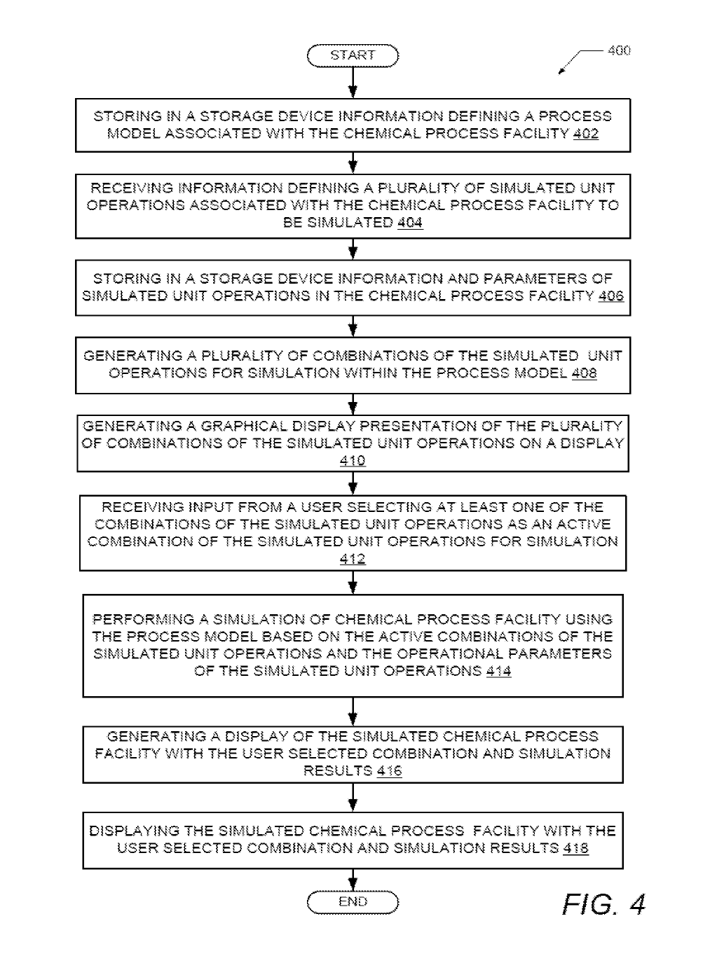

FIG. 4 is a flow chart showing step in an example method 400 of simulating a chemical process facility. With reference to FIGS. 1-4, method 400 can be implemented via the execution of instructions 224 and/or algorithms 225 by processor 202 within process simulation computer 190 and specifically by the execution of process modeling software 194 by processor 202. Method 400 begins at the start block and proceeds to block 402. At block 402, processor 202 stores in a storage device such as memory 192, process models 232 associated with the chemical process facility 102. At block 404, processor 202 receives information defining the flowsheet 103, the flowsheet topology, the simulated unit operations (simulated processing elements 234 representing chemical process operations and simulated fixed flow streams 236 representing flows of material between unit operations 105a, 105b, 105c). Also at block 404, processor 202 receives process parameters 238 and process variables 240.

At block 406, processor 202 stores in memory 192 information and parameters including simulated processing elements 234, simulated flow streams 236, process parameters 238 and process variables 240. At block 408, processor 202 generates a plurality of combinations 180 (operation options) of the simulated unit operations for simulation within the process models 232. Each of the combinations represents a fixed set of the unit operations 105a, 105b, 105c to be simulated.

At block 410, processor 202 generates a graphical display presentation of the combinations of the simulated unit operations on a display and displays the graphical display presentation on display 196. Each of the unit operations 105a, 105b, 105c are shown on display 196 with several user selectable unit operation options (170, 172, 174) that each have its own stored specification parameters.

At block 412, processor 202 receives input from a user (user input 242) from an input device 260 selecting at least one of the combinations 180 of the simulated unit operations as an active combination of the simulated unit operations to be simulated. Using the graphic user interface, the user is allowed to select at least one set of the operation options (170, 172, 174) including one selection from each of the unit operations 105a, 105b, 105c. The combinations of the simulated unit operations not selected by the user are designated as inactive combinations of the simulated unit operations. In one embodiment the combinations of the operation options (including the selected combination of operation options) are represented as a set of integer options in the chemical process simulator system 100.

At block 414, processor 202 performs a simulation of the chemical process facility using the process models 232 and based on the user selected operation options (combination) of the simulated unit operations and the operational parameters of the simulated unit operations. In one embodiment, the chemical process simulator system 100 can use mixed-integer nonlinear programming (MINLP) techniques using the set of integer options to identify the optimal combination of operation options of the chemical process facility in an efficient manner. The integer options are variables in MINLP optimization. MINLP combines the combinatorial difficulty of optimizing discrete variable sets with the challenges of handling nonlinear functions. MINLP includes both nonlinear programming (NLP) and mixed-integer linear programming (MILP) as sub-problems.

At block 416, processor 202 generates a graphical display presentation (i.e. screenshot 302 shown in FIG. 3) of the user' selected combination of the simulated unit operations and simulation results. Screenshot 302 includes the flowsheet topology customized with the first specific set of the operation options (170, 172, 174) selected by the user. At block 418, processor 202 displays the graphical display presentation (screenshot 302) on display 196. Screen shot 302 shows the user' selected flowsheet topology customized with the user selected set of the operation options. Method 400 then ends.

In one embodiment, block 414 of method 400 can include running multiple process simulations using the process model customized with the user' selected combination of operations options. Block 416 of method 400 can include a screenshot 302 that shows a comparison comparing the performance results of at least one simulated flow stream result 315 from the multiple process simulations.

The user can utilize disclosed simulation results generated to efficiently compare the results of various process configurations or the results of various process models. The ability to quickly evaluate multiple scenarios or tune across the discrete combinations provided will improve the efficiency of the chemical plant design process and the quality of the final chemical plant design.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

Any combination of one or more computer usable or computer-readable medium(s) may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

1. A method of simulating a chemical process, comprising:
providing a process simulator comprising a processor configured to execute a stored process model for simulating said chemical process using a flowsheet having a flowsheet topology, said flowsheet topology defining a general flow of said chemical process including a plurality of unit operations connected by fixed process stream connections, said process simulator having an associated display with a graphic user interface (GUI) for interacting with a user, wherein said process simulator represents each of said plurality of unit operations on said display with a plurality of user selectable unit operation options (operation options) each having its own stored specification parameters;
using said GUI, allowing said user to select at least a first specific set of said operation options including one selection from each of said operation options;
using said first specific set of said operation options, said process simulator generating said flowsheet topology customized with said first specific set of said operation options, and
generating a graphical display presentation on said display showing said flowsheet topology customized with said first specific set of said operation options.

2. The method of claim 1, further comprising running a first and at least a second simulation using said process model with a first and a second said flowsheet topology customized, and comparing performance results of at least one process output from said first and second simulations.

3. The method of claim 2, wherein said flowsheet topology further includes at least one nested sub-flowsheet.

4. The method of claim 1, wherein a combination of said operation options are represented as a set of integer options.

5. The method of claim 4, wherein said process simulator supports mixed-integer non-linear programming optimization (MINLP), and wherein said integer options are variables in an optimization.

6. The method of claim 2, wherein said first specific set of said operation options are shown on said display with a first indicia and at least one non-selected operation option is shown on said display with a second indicia.

7. A process simulation system, comprising:
a process simulation computer (process simulator) including a processor connected to a memory device having a first non-transitory machine-readable storage medium storing process modeling software, wherein said processor is programmed to implement said process modeling software causing said process simulator to:
execute a process model for simulating a chemical process using a flowsheet having a flowsheet topology, said flowsheet topology defining a general flow of said chemical process including a plurality of unit operations connected by fixed process stream connections, said process simulator having an associated display with a graphic user interface (GUI) for interacting with a user;
said process simulator representing each of said plurality of unit operations on said display with a plurality of user selectable unit operation options (operation options) each having its own stored specification parameters;
using said GUI, allow said user to select at least a first specific set of said operation options including one selection from each of said operation options;
using said first specific set of said operation options, said process simulator generates said flowsheet topology customized with said first specific set of said operation options, and
generate a graphical display presentation on said display showing said flowsheet topology customized with said first specific set of said operation options.

8. The system of claim 7, further comprising running a first and at least a second simulation using said process model with a first and a second said flowsheet topology customized, and comparing performance results of at least one process output from said first and second simulations.

9. The system of claim 7, wherein said flowsheet topology further includes at least one nested sub-flowsheet.

10. The system of claim 7, wherein a combination of said operation options are represented as a set of integer options.

11. The system of claim 10, wherein said process simulator supports mixed-integer non-linear programming optimization (MINLP), and wherein said integer options are variables in an optimization.

12. The system of claim 7, wherein said first specific set of said operation options are shown on said display with a first indicia and at least one non-selected operation option is shown on said display with a second indicia.

13. A computer program product, comprising:
a memory device having a non-transitory data storage medium that includes program instructions executable by a processor to enable said processor to provide a process simulator that executes a method for simulating a chemical process, said computer program product comprising:
code for executing a process model for simulating said chemical process using a flowsheet having a flowsheet topology, said flowsheet topology defining a general flow of said chemical process including a plurality of unit operations connected by fixed process stream connections, said process simulator having an associated display with a graphic user interface (GUI) for interacting with a user;
code for said process simulator to represent each of said plurality of unit operations on said display with a plurality of user selectable unit operation options (operation options) each having its own stored specification parameters;
code for allowing said user to use said graphical user interface to select at least a first specific set of said operation options including one selection from each of said operation options;
using said first specific set of said operation options, code for said process simulator to generate said flowsheet topology customized with said first specific set of said operation options, and
code for generating a graphical display presentation on said display showing said flowsheet topology customized with said first specific set of said operation options.

14. The computer program product of claim 13, wherein said computer program product further comprises:
code for running a first and at least a second simulation using said process model with a first and a second said flowsheet topology customized, and comparing performance results of at least one process output from said first and second simulations.

15. The computer program product of claim 14, wherein said flowsheet topology further includes at least one nested sub-flowsheet.

16. The computer program product of claim 13, wherein a combination of said operation options are represented as a set of integer options.

17. The computer program product of claim 16, wherein said process simulator supports mixed-integer non-linear programming optimization (MINLP), and wherein said integer options are variables in an optimization.

18. The computer program product of claim 14, wherein said first specific set of said operation options are shown on said display with a first indicia and at least one non-selected operation option is shown on said display with a second indicia.
